(19) United States
(12) Patent Application Publication
(10) Pub. No.: US 2006/0093306 A1
(43) Pub. Date: May 4, 2006

(54) Photonic crystal and manufacturing method thereof

(75) Inventors: Akira Kawasaki, Sendai-shi (JP); Kenta Takagi, Sendai-shi (JP)

Correspondence Address: KANESAKA BERNER AND PARTNERS LLP, SUITE 300, 1700 DIAGONAL RD, ALEXANDRIA, VA, 22314-2848, US

(73) Assignees: AKIRA KAWASAKI (Individual), Sendai-shi (JP); J-TEC, INC., Tokyo (JP)

(21) Appl. No.: 11/255,964

(22) Filed: Oct. 24, 2005

Related U.S. Application Data
(60) Provisional application No. 60/622,840, filed on Oct. 29, 2004.

(51) Int. Cl. G02B 6/00

(52) U.S. Cl. 385/147

(57) ABSTRACT

A three-dimensional photonic crystal having a wide and sharp bandgap, a manufacturing method thereof, a structural body for manufacturing this photonic crystal, and a manufacturing method thereof are provided. The structural body is formed by placing monodisperse particles in a recess having a regular quadrangular pyramid shape formed in a container, arranging the particles three-dimensionally by applying vibration, and performing sintering, so that adjacent particles are connected to each other with necks provided therebetween. A dielectric resin is impregnated in voids of the structural body and is then cured to form a composite. The composite is immersed in a solution which dissolves only the structural body. Monodisperse particles exposed at the surface of the composite are dissolved, and monodisperse particles adjacent thereto with necks provided therebetween are then sequentially dissolved, so that the whole structural body is finally dissolved. Hence, a photonic crystal composed of the dielectric resin is manufactured.

### FIELD OF THE INVENTION

The present invention relates to a three-dimensional photonic crystal, a manufacturing method thereof, a structural body used for manufacturing this photonic crystal, and manufacturing method of the structural body.

### BACKGROUND OF THE INVENTION

In recent years, photonic crystals have drawn great attention as a material for low-transmission loss devices in light fields.

In addition, recently, proposals have been made to use this photonic crystal for terahertz-wave applications. Electromagnetic waves in the region of approximately 0.1 THz (λ=3 mm) to 10 THz (λ=30 mm) is located between light waves and electric waves in terms of wavelength and are called terahertz waves. In the terahertz wave region, characteristic frequencies of almost all molecules are present, and when an organic material is irradiated with a terahertz wave having a characteristic wavelength of a specific molecule present in the organic material, selective excitation reaction is allowed to occur. In addition, to the contrary, when a terahertz wavelength absorbed in the proper oscillation is detected, identification of a molecule may also be performed. As applications in the terahertz wave regions, for example, cancer treatment and biological imaging may be mentioned, and hence contribution to medical care fields is also greatly expected. In addition, electromagnetic waves in the terahertz wave region may be diversely used, for example, in large capacity communication called super-multiplex optical communication and non-destructive inspection for the inside of semiconductors.

As described above, a photonic crystal which has drawn attention in light and terahertz wave fields is an artificial crystal formed of dielectrics which are periodically arranged. When an electromagnetic wave having a wavelength approximately equal to the lattice constant of this crystal is incident thereon, two standing waves are present in the crystal. Although the wave numbers of the two waves are equal to each other, the energies thereof are different from each other, and hence a wave having an energy therebetween cannot be present in the crystal. In this case, a phenomenon called a photonic bandgap occurs. That is, electromagnetic waves corresponding to wavelengths of the photonic bandgap are to be totally reflected. Furthermore, when a defect is intentionally formed in the periodical structure of a photonic crystal, devices such as a waveguide, resonator, and an electromagnetic wave filter may be formed. In addition, since a perfect scaling rule holds between the lattice constant and the wavelength in a photonic crystal, when a photonic crystal corresponding to the wavelength of an electromagnetic wave is formed, desired electromagnetic wave control can be practically performed.

As a photonic crystal, a two-dimensional photonic crystal has been generally used. In PCT Japanese Translation Patent Publication No. 2004-522201, a two-dimensional photonic crystal has been disclosed which has a crystal defective portion having a longitudinal axis and a photonic crystal portion having a longitudinal axis and surrounding the crystal defective portion. The photonic crystal portion has an array composed of a plurality of plastic elements forming a two-dimensional crystal structure, and a cross-section perpendicular to the longitudinal axis of the two-dimensional photonic crystal has a lattice constant of several millimeters or less.

A photonic crystal may be formed, for example, by a micro electro mechanical system (MEMS) or a stereo lithographic method. In both cases, since a millimeter-order periodical structure is preferably formed, control of millimeter waves has been satisfactorily performed. In the case of a photonic crystal used for visible light, by using a photolithographic method, an artificial crystal having an order of several hundreds to several tens of nanometers is generally formed.

The inventors of the present invention developed a monodisperse particle formation method called a pulsated orifice ejection method (hereinafter referred to as “POEM”) and successfully formed particles having a significantly uniform particle size in the range of several tens to several hundreds of micrometers (S. Masuda, K. Takagi, Y. S. Kang, and A. Kawasaki: “Fabrication and Microstructural Characteristics of Germanium Spherical Semiconductor Particles by Pulsated Orifice Ejection Method”, J. Japan. Soc. Powder and Powder Metallurgy 51, (2004) pp. 646 to 654).

In the POEM, a molten metal is filled in a crucible provided with a small hole in a bottom wall thereof, and a pulse pressure is applied by a piezoelectric actuator to the crucible, so that droplets of the molten metal having a constant volume are dripped through the small hole. The ejected droplets of the molten metal are formed into spheres due to its own surface tension and are solidified during dripping. According to the POEM, monodisperse particles having uniform particle sizes can be efficiently formed.

When a photonic crystal is formed by the MEMS or stereo lithographic method, in view of the accuracy and formation rate, it is difficult to form a three-dimensional photonic crystal having a wide and sharp bandgap. Hence, most photonic crystals have a two-dimensional structure, and there have been a small number of examples of forming a three-dimensional photonic crystal.

### SUMMARY OF THE INVENTION

In accordance with a first aspect of the present invention, there is provided a structural body used for manufacturing a photonic crystal in which air spheres are three-dimensionally arranged in a dielectric. In this structural body, monodisperse particles are three-dimensionally arranged and are each connected to at least one adjacent monodisperse particle with a neck provided therebetween.

In accordance with a second aspect of the present invention, there is provided a method for manufacturing a structural body used for manufacturing a photonic crystal in which air spheres are three-dimensionally arranged in a dielectric. In the method described above, monodisperse particles are placed in a container and are then three-dimensionally arranged by applying vibration, followed by sintering, so that the particles are each connected to at least one adjacent monodisperse particle with a neck provided therebetween to form the structural body.

In accordance with a third aspect of the present invention, there is provided a method for manufacturing a photonic crystal in which air spheres are three-dimensionally arranged in a dielectric. In the method described above, after a dielectric resin is impregnated in voids present in the structural body manufactured by the manufacturing method described in the second aspect of the present invention and is then cured to form a composite, the composite is immersed in a solution which dissolves only the structural body of the composite so as to remove the structural body by dissolution, whereby a photonic crystal comprising the dielectric resin is formed.

In accordance with a fourth aspect of the present invention, there is provided a photonic crystal including a dielectric and air spheres arranged three-dimensionally in the dielectric.

### BRIEF DESCRIPTION OF THE DRAWINGS

FIG. 1A is a plan view showing a container having a recess in the form of a regular quadrangular pyramid;

FIG. 1B is a cross-sectional view of the container shown in FIG. 1A taken along line Ib-Ib;

FIG. 1C is a cross-sectional view of the container shown in FIG. 1A taken along line Ic-Ic;

FIG. 2 is a SEM photograph showing monodisperse particles having a particle diameter of 344 μm, formed by a POEM;

FIG. 3 is a graph showing the relationship between a neck diameter and a sintering temperature at which one-dimensionally arranged monodisperse particles are sintered:

FIG. 4 is a graph showing the relationship between the dielectric constant and the amount of a Si, a SiO₂, or a TiO₂ powder mixed with an epoxy resin:

FIG. 5A is a SEM photograph showing a structural body composed of monodisperse particles having an average particle diameter of 267 μm (standard deviation: 6.67);

FIG. 5B is a SEM photograph showing a neck portion;

FIG. 6 is a SEM photograph showing a photonic crystal obtained by impregnating a structural body with an epoxy resin containing 10 percent by volume of TiO₂, followed by removal of monodisperse particles by dissolution;

FIG. 7 is a SEM photograph showing the (111) plane of a photonic crystal which is polished in parallel to the (111) plane;

FIG. 8A is a graph showing measurement values of electromagnetic wave transmission properties of an epoxy resin plate and a photonic crystal which is obtained by impregnating the structural body shown in FIG. 5 with an epoxy resin, followed by removal of the monodisperse particles by dissolution;

FIG. 8B is a graph showing measurement values of electromagnetic wave transmission properties of the photonic crystal shown in FIG. 6 and an epoxy resin plate containing 10 percent by weight of TiO₂; and

FIG. 9 is a graph showing analytical results by a plane-wave analysis method based on conditions in which air spheres are arranged to form a face-centered cubic (fcc) structure and the dielectric constant of the lattice is regarded as 2.72 which is a measurement value of an epoxy resin.

### DESCRIPTION OF THE PREFERRED EMBODIMENTS

A photonic crystal is manufactured by impregnating voids of a structural body composed of three-dimensionally arranged monodisperse particles with a dielectric, and curing the dielectric, followed by removal of the monodisperse particles.

A structural body used for manufacturing a photonic crystal, according to the present invention, has the structure in which monodisperse particles are three-dimensionally arranged and are each connected to at least one adjacent monodisperse particle with a neck provided therebetween, so that this structural body has a three-dimensional spherical lattice structure. Hence, a photonic crystal manufactured by using this structural body has air spheres of a three-dimensional spherical lattice structure, and as a result, a wide and sharp bandgap close to that obtained by theoretical calculation can be realized.

In the structural body used for manufacturing a photonic crystal, when the lattice constant of the structural body is in the range of 0.03 to 3 mm, a photonic crystal usable in a terahertz wave region can be manufactured using this structural body.

In the structural body used for manufacturing a photonic crystal, as the monodisperse particles, monodisperse particles are preferably used which are obtained by the steps of filling a molten raw material in a crucible provided with a small hole, and dripping droplets of the molten raw material each having a constant volume by applying a pulse pressure to the crucible so that the droplets of the molten raw material are formed into spheres due to its own surface tension and are also solidified during dripping. In this case, since the monodisperse particles thus formed have a very uniform particle size, the lattice constant of the three-dimensional spherical lattice structure composed of the monodisperse particles can be very precisely controlled.

In the structural body used for manufacturing a photonic crystal, when being formed of a metal such as copper, the monodisperse particles can be easily dissolved by using a solution; hence, the photonic crystal can be easily manufactured using this-structural body.

In the structural body used for manufacturing a photonic crystal, the monodisperse particles may be arranged to form a face-centered cubic structure.

This structural body used for manufacturing a photonic crystal can be easily manufactured by the steps of placing monodisperse particles in a container; arranging the particles three-dimensionally by applying vibration; and performing sintering so that the particles are each connected to at least one adjacent monodisperse particle with a neck provided therebetween.

A photonic crystal composed of a dielectric resin is obtained by the steps of impregnating voids of the structural body with a dielectric resin, followed by curing to form a composite, and immersing the composite in a solution dissolving only the structural body so as to remove the structural body by dissolution.

In the manufacturing method described above, when the composite is immersed in the solution, monodisperse particles exposed at the surface of the composite are first dissolved in the solution, and subsequently, necks and monodisperse particles adjacent thereto are dissolved in the solution. Since monodisperse particles adjacent to each other with necks provided therebetween are sequentially dissolved in the solution as described above, the structural body is totally dissolved therein, and as a result, a photonic crystal composed of the dielectric resin is obtained.

In the photonic crystal manufactured as described above, since the air spheres present therein form a three-dimensional spherical lattice structure, a wide and sharp bandgap can be obtained which is closed to that obtained by theoretical calculation.

In this method for manufacturing a photonic crystal, it is preferable that the monodisperse particles be composed of copper, the solution be an aqueous ferric chloride solution, and the dielectric resin be an epoxy resin containing at least one of Si, SiO₂, and TiO₂.

In this photonic crystal, since the air spheres are three-dimensionally arranged in a dielectric, a wide and sharp bandgap can be obtained which is close to that obtained by theoretical calculation.

Hereinafter, preferable embodiments of the present invention will be described in detail with reference to figures.

A structural body used for manufacturing a photonic crystal, according to a preferable embodiment, has the structure in which monodisperse particles are three-dimensionally arranged and are each connected to at least one adjacent monodisperse particle with a neck provided therebetween.

This structural body can be manufactured, for example, by the steps of placing monodisperse particles in a recess 1a of a container 1, the recess 1a having a regular quadrangular pyramid shape, arranging the monodisperse particles three-dimensionally by applying vibration, and then performing sintering so that adjacent monodisperse particles are connected to each other with necks provided therebetween.

As a material for the monodisperse particles, for example, there may be mentioned a pure metal such as Cu, Sn, or Ni, a metal such as SnPb, SnAg, or BiSb, or a semiconductor such as Si or Ge; however, since being easily removed by dissolution in a dissolving step which will be described later, a metal such as Cu, Sn, or Ni, and in particular, Cu is preferable.

For example, the three-dimensional structure of the monodisperse particles is preferably a face-centered cubic structure. In the structural body having a face-centered cubic structure, it has been theoretically known that a perfect bandgap for all directions can be realized when the dielectric constant is increased.

In the photonic crystal, since a perfect scaling rule holds between the lattice constant and the wavelength at which the photonic bandgap phenomenon occurs, the lattice constant of the structural body is set so as to correspond to the wavelength of a desired photonic bandgap, and in order to realize a photonic bandgap phenomenon in a terahertz wave region, for example, the lattice constant and the particle diamante of the monodisperse particles are approximately 0.1 to 3 mm and approximately 0.05 to 1.5 mm, respectively.

In forming the structural body, after the monodisperse particles are three-dimensionally arranged, it is necessary to form necks by sintering which have appropriate bonding strengths between adjacent particles and which are sufficiently large so as to impregnate the composite with a dissolving solution. The neck diameter is optionally determined depending on the material and particle diameter of the monodisperse particles, the type of solution, the concentration thereof, and the like; however, the neck diameter is preferably 20 to 50 μm or is preferably approximately 10% to 20% of the particle diameter. When the neck diameter is less than 20 μm or less than 10%, the solution may not be sufficiently impregnated in the composite through the necks. When the neck diameter is more than 50 μm or more than 20%, since the distance between particles is decreased by sintering, so-called contraction occurs, and the lattice constant deviates from a desired value. In addition to that, since non-uniform contraction inevitably occurs, the lattice is distorted, and as a result, a precise periodic structural body may not be obtained in some cases. Furthermore, even when the contraction uniformly occurs, an excessively large neck diameter may inhibit the impregnation of the structural body with the resin in some cases.

The monodisperse particles are preferably manufactured by a POEM. In the POEM, a molten raw material is filled in a crucible provided with a small hole, and droplets of the raw material having a constant volume are dripped through the small hole by applying a pulse pressure to the crucible. The droplets are formed into spheres due to its own surface tension and are also solidified during dripping. The monodisperse particles are manufactured as described above. According to this POEM, monodisperse particles having uniform particle diameters can be very efficiently manufactured. In this method, as the pulse pressure, for example, a pulse at a pressure of approximately 0 to 2 kPa and at a frequency of approximately 10 to 100 Hz is applied.

A dielectric resin is impregnated in the voids of the structural body thus obtained and is then cured to form a composite, and this composite is then immersed in a solution dissolving only the structural body of the composite. In this step, monodisperse particles exposed at the surface of the composite are first dissolved in the solution, necks of the above monodisperse particles and adjacent monodisperse particles connected thereto through the necks are then dissolved in the solution, and subsequently, monodisperse particles remaining in the composite are dissolved in the solution in the same manner as described above. Hence, finally, the structural body is totally dissolved.

Subsequently, after washing and drying are performed whenever necessary, the photonic crystal composed of a dielectric resin can be manufactured.

As the dielectric resin, for example, there may be mentioned a synthetic resin such as an epoxy or a polyethylene resin or a resin material containing a dielectric powder dispersed therein.

The resin material is not particularly limited as long as it transmits an electromagnetic wave having a desired wavelength, and in accordance with the application, any material may be optionally selected. However, in consideration of requirement of highly precise workability, for example, a synthetic resin, such as a thermoplastic resin or a curable resin including a thermosetting resin or a photocurable resin, is preferably used.

The thermoplastic resins are not particularly limited and may be optionally selected in accordance with the application, and for example, there may be mentioned addition polymerization type resins such as polyethylene, polypropylene, poly(vinyl chloride), polystyrene, poly(vinylidene chloride), fluorinated resin, and poly(methylmethacrylate); polycondensation type resins such as polyamide, polyester, polycarbonate, and poly(phenylene oxide); and polyaddition type resins such as thermoplastic polyurethane; and ring-opening polymerization type resin such as polyacetal.

As the curable resins, for example, there may be mentioned epoxy resin, phenol resin, polyurethane resin, unsaturated polyester resin, urea resin, and melamine resin. The curable resins mentioned above may be compounded with various fillers such as glass fibers, wood flour, pulp, asbestos, and calcium carbonate.

As the dielectric powder, for example, there may be mentioned oxide-based ceramics such as SiO₂, TiO₂, CeO₂, Y₂O₃, Al₂O₃, and LiNbO₃, nitride-based ceramics, carbide-based ceramics, Si, and Ge.

The dielectric constant of the dielectric resin is, for example, 2 or more, and the amount of the dielectric powder contained in the dielectric resin is, for example, in the range of 0 to 30 percent by volume.

Impregnation of the structural body with the dielectric resin is preferably performed under vacuum conditions at approximately 0.5 to 0.01 Pa.

The solution dissolving the structural body is optionally selected in accordance with the material of the monodisperse particles, and for example, there may be mentioned an aqueous ferric chloride (FeCl₃) solution, an aqueous hydrogen fluoride solution, an aqueous hydrochloric acid solution, an aqueous sulfuric acid solution, and an aqueous sodium hydroxide solution.

When the structural body is removed by dissolution from the composite composed of the structural body impregnated with the dielectric resin, after some monodisperse particles are exposed at surfaces of the composite by polishing or the like, the composite is preferably immersed in the solution while ultrasonic waves are being applied thereto.

Since the photonic crystal thus obtained has a spherical lattice structure composed of air spheres present therein, a wide and sharp bandgap close to that obtained by theoretical calculation can be realized. The reasons the wide and sharp bandgap close to that obtained by theoretical calculation is realized by the spherical lattice structure are as follows. That is, the photonic crystal as described above has a superior three-dimensional symmetry, and in the three-dimensionally periodic structure thereof, a crystal structure can be precisely reproduced; hence, the three-dimensionally periodic structure is close to an ideal structure. In addition, since dielectric spots and connection portions provided therebetween are clearly distinguished from each other and form a network structural body, the dielectric constant and the radius of the sphere can determine the entire characteristics of the photonic crystal.

### EXAMPLES

Hereinafter, the present invention will be described in more detail with reference to examples; however, the present invention is not limited thereto.

(Formation of Monodisperse Particles)

Monodisperse particles were formed using copper by a POEM. In the POEM, molten copper was filled in a crucible provided with a small hole in the bottom wall thereof, and by applying a pulse pressure (pressure: 2 kPa, and frequency: 10 Hz) using a piezoelectric actuator, droplets of the molten copper having a constant volume were ejected through the small hole. The molten droplets thus ejected were formed into spheres due to its own surface tension and were solidified during dripping, so that spherical monodisperse particles were formed. In this example, pure copper was used since it can be formed into particles by the POEM and can be easily removed by dissolution using a chemical process.

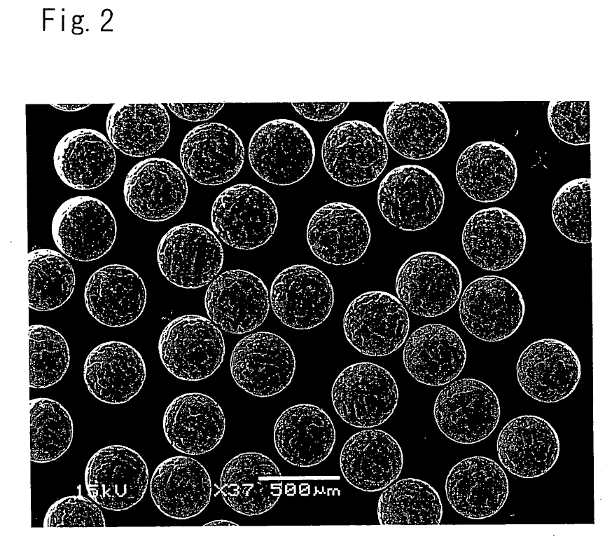

Monodisperse particles were formed having four different particle diameters of 267 μm (standard deviation: 6.67), 270 μm, 344 μm, and 482 μm. FIG. 2 is a SEM photograph of the monodisperse particles having a particle diameter of 344 μm formed by the POEM.

(Investigation of Sintering Conditions)

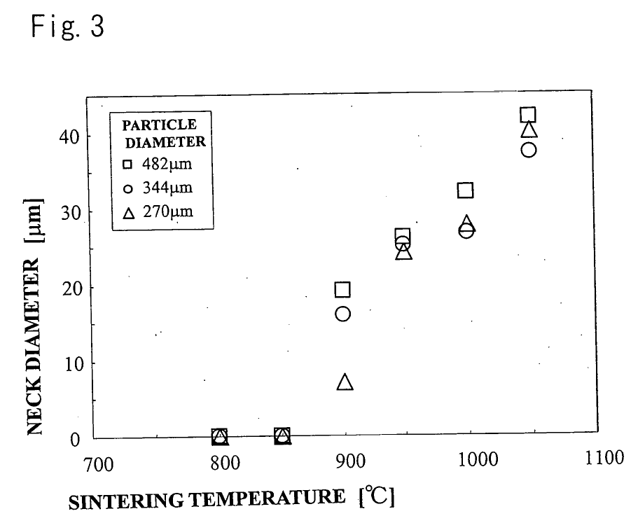

In order to form the structural body, after the monodisperse particles were three-dimensionally arranged, necks must be formed by sintering which have appropriate bonding strengths between adjacent particles and which are sufficiently large so as to impregnate the composite with a dissolving solution. Accordingly, the sintering conditions were investigated using the structure which is composed of one-dimensionally arranged monodisperse copper particles. Three types of monodisperse copper particles having average particle diameters of 270, 344, and 482 μm were prepared and were each one-dimensionally arranged in an inclined V-shaped groove. Next, the monodisperse particles thus arranged as described above were processed by reduction treatment at 400° C. for 1 hour in a hydrogen atmosphere. Subsequently, in a hydrogen atmosphere, sintering was performed for 30 minutes at various temperatures in the range of 800 to 1,050° C. The one-dimensionally arranged structural bodies thus formed were observed using a SEM, and the neck diameters formed at the various temperatures were measured. The results are shown in FIG. 3.

(Formation of Dielectric Resin)

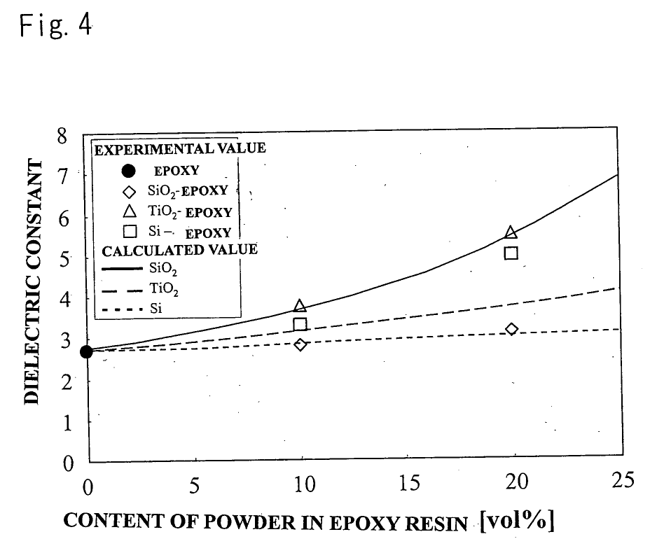

It has been known that the dielectric constant of a dielectric resin has considerable influence on the position and the width of the photonic bandgap. Accordingly, the dielectric constant was controlled by mixing a dielectric powder with a resin. As the resin, a two-component curable epoxy resin (Araldite CY221 manufactured by Nagase Chemtex Corp.) was selected which had a low viscosity and was suitably used for impregnation. In addition, as candidates of dielectric powders, three types of powders were prepared, that is, they were pure Si (average particle diameter: 10 μm, manufactured by Mitsuwa Chemicals Co., Ltd.), SiO₂ (average particle diameter: 0.8 μm, manufactured by Kojundo Chemical Laboratory Co., Ltd.), and TiO₂ (average particle diameter: 1 μm, manufactured by Kojundo Chemical Laboratory Co., Ltd.), each being a dielectric having a bandgap which is not electronic-excited by energy of a terahertz wave. After 0, 10, and 20 percent by volume of each powder were mixed with an epoxy resin using a mortar and were then vacuum deaerated (pressure: 10 Pa), curing was performed by adding a curing agent (Hardner HY951 manufactured by Nagase Chemtex Corp). The cured product thus obtained was formed into a flat plate having a thickness of 2 mm, and the dielectric constant thereof in a terahertz wave region (0.01 to 3 THz) was measured using a terahertz pulse spectrometer (THz-TDS 2000 ms manufactured by Mutsumi Corporation, hereinafter simply referred to as “THz-TDS”). The results are shown in FIG. 4. FIG. 4 shows the dielectric constants obtained when the individual powders, Si, SiO₂, and TiO₂, were mixed with an epoxy resin by changing a mixing volume percent. The dielectric constant shown in this figure was an average value in the region of 0.1 to 1.5 THz.

The rule of mixture regarding the dielectric constant can be represented by the following equations.
ε=[(3x₁−1)ε₁+(3x₂−1)ε₂+√D]/4
D=(3x₁−1)ε₁+(3x₂−1)ε₂+8ε₁ε₂ (1)

As the dielectric constants of the epoxy resin, SiO₂, TiO₂, and Si, εᵣₑₛᵢₙ=2.72, ε_{SiO2}=4.45, ε_{TiO2}=81.00, and ε_{Si}=11.68 were used, respectively, and the result obtained using equation (1) is shown by a curve in FIG. 4.

(Formation of Structural Body)

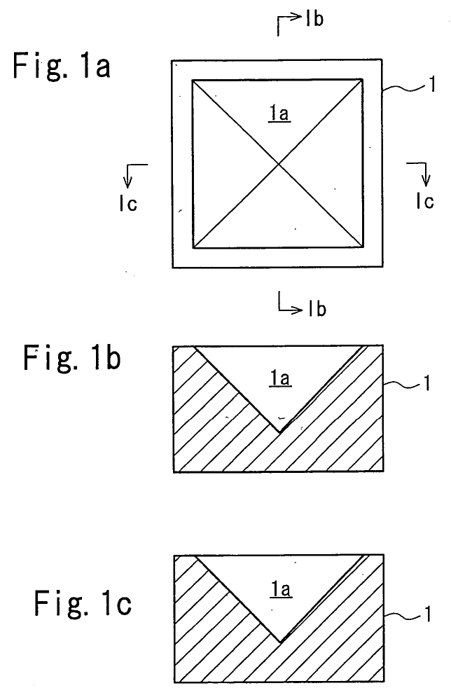

As for the formation of a three-dimensional structural body using monodisperse copper particles, it has been known that spheres placed in a recess having a regular quadrangular pyramid shape is self-arranged by vibration and by its own weight to form a face-centered cubic structure (fcc structure). Accordingly, in a recess 1a in the form of a regular quadrangular pyramid provided in a container 1 as shown in FIG. 1, the monodisperse particles having an average particle diameter of 267 μm (standard deviation: 6.67) were filled, and an appropriate vibration was applied thereto, so that a fcc structure was formed by self-arrangement. In the recess 1a, the length of one side of the quadrangle at the upper side (open side) of the recess la was 10 mm, and the depth thereof was 7 mm.

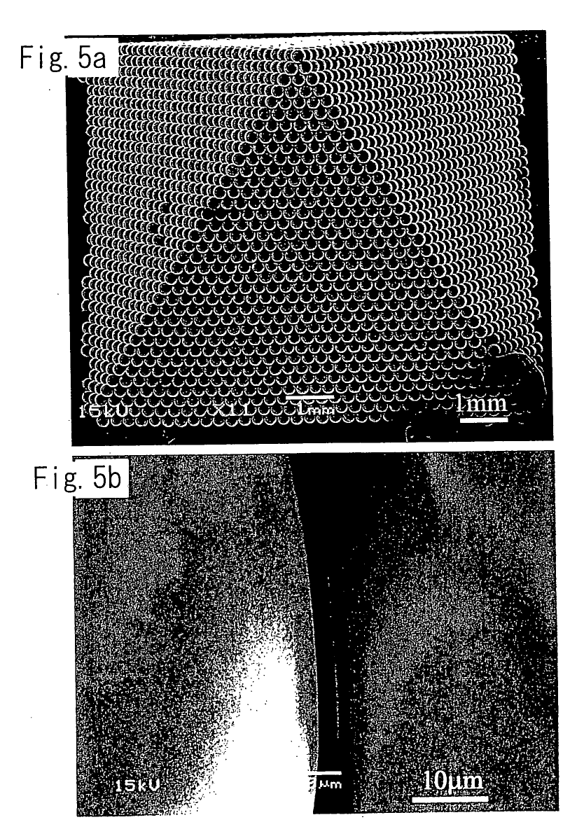

Next, after reduction treatment equivalent to that described above was performed, sintering was performed at 1,050° C. for 30 minutes in a hydrogen atmosphere, so that a structural body in the form of a regular quadrangular pyramid was formed in which the length of one side at the bottom was 10 mm and the height was 6 mm. FIG. 5A is a SEM photograph of a structural body formed by sintering the monodisperse particles having an average particle diameter of 267 μm (standard deviation: 6.67), and FIG. 5B is a SEM photograph of a neck portion of the above structural body.

(Formation of Photonic Crystal)

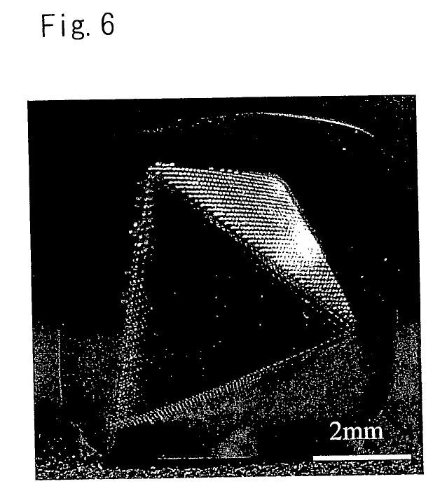

In voids of two structural bodies formed as described above, a dielectric resin composed of an epoxy resin and 10 percent by volume of TiO₂ and a dielectric resin only composed of an epoxy resin were separately filled by vacuum impregnation, followed by curing. After the resin was fully cured, and some copper particles were exposed at the surface by polishing, while ultrasonic waves were being applied, the structural body impregnated with the dielectric resin was immersed in an aqueous ferric chloride solution (manufactured by Wako Pure Chemical Industries, Ltd.) so that the copper particles embedded inside were totally dissolved, thereby forming a photonic crystal. In FIG. 6, a SEM photograph of a photonic crystal is shown which was obtained by impregnating the structural body with an epoxy resin containing 10 percent by volume of TiO₂, followed by curing, and then removing the copper particles by dissolution.

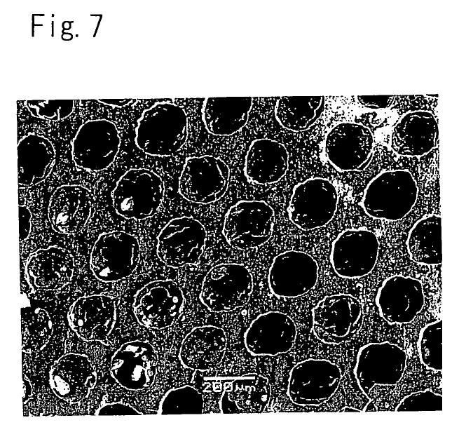

In the fcc structure, since it has been known that the gap appears in the <111> direction, the two types of structural bodies each having a regular quadrangular pyramid shape thus obtained were polished to form a plate having a thickness of 2 mm so that the <111> direction coincided with the thickness direction. FIG. 7 is a SEM photograph of the (111) plane obtained by polishing the photonic crystal in parallel to the (111) plane thereof.

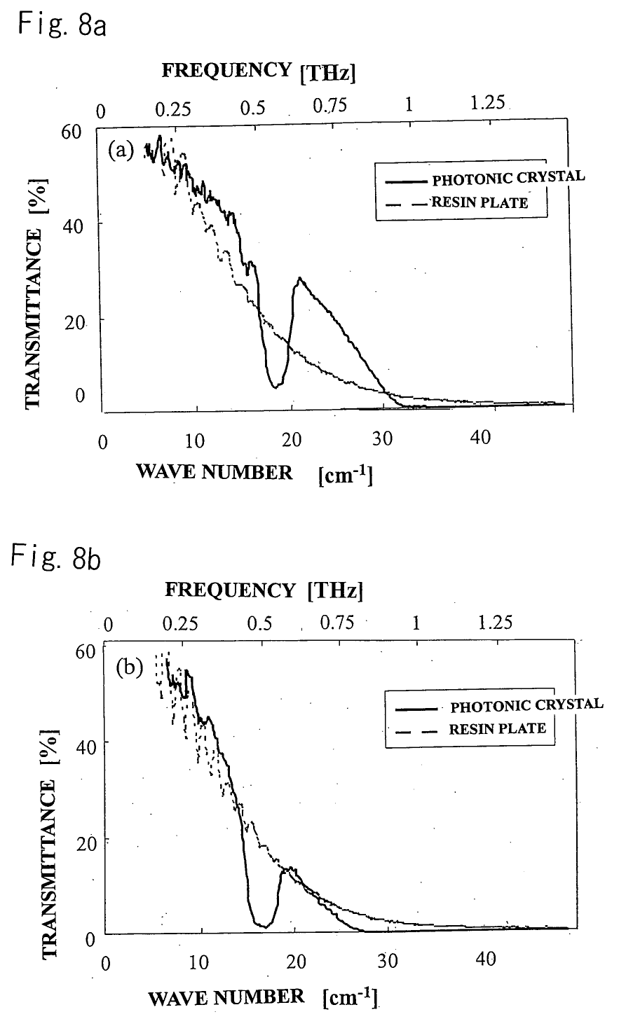

Next, terahertz-wave transmission properties were measured by THz-TDS. In addition, terahertz-wave transmission properties were measured by THz-TDS for a 2 mm-thick solid body only composed of an epoxy resin and a 2-mm thick solid body composed of an epoxy resin and 10 percent by volume of TiO₂. The results are shown in FIGS. 8A and 8B. FIG. 8A shows the results of electromagnetic-wave transmission properties of the photonic crystal only composed of the epoxy resin, which were measured by THZ-TDS. FIG. 8B shows the results of electromagnetic-wave transmission properties of the photonic crystal composed of the epoxy resin and 10 percent by volume of TiO₂, which were measured by THZ-TDS. The solid lines in FIGS. 8A and 8B indicate the terahertz-wave transmission properties of the photonic crystals, and dotted lines indicate the terahertz-wave transmission properties of the solid bodies each having no three-dimensional air sphere lattice structure.

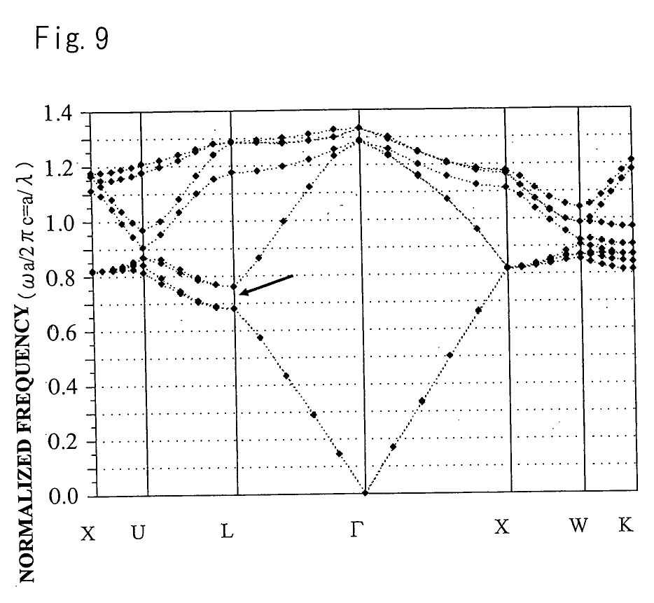

In order to confirm whether the attenuation region of the transmission was caused by the photonic gap, a numerical analysis of the dispersion relation was carried out in accordance with a plane wave expansion method and was compared with the measurement results obtained by THz-TDS. As the plane wave expansion method, commercially available software (Band SOLVE manufactured by Rsoft Design Group, Inc.) was used, and the analytical model was regarded as that the change in shape of the lattice caused by the necks formed when the copper particles were actually sintered could be ignored and that the spherical lattices were in point contact with each other to form a fcc structure. In FIG. 9, the analytical result is shown which was obtained based on the case in which air spheres were assumed to be most closely arranged to form a fcc structure and in which the calculation was performed using 2.72, the measurement value of the epoxy resin, as the dielectric constant of the lattice.

(Results)

I. Monodisperse Copper Particles

As shown in FIG. 2, it is understood that the monodisperse copper particles having a particle diameter of 344 μm formed by the POEM have uniform spherical shapes and that the particle diameters thereof are very uniform. Although slight surface undulations are observed on the particle surfaces which are caused by grain boundaries generated in solidification, considerable distortion of the spherical shape is not observed. This phenomenon can also be observed for all the spherical monodisperse particles used in this example.

II. Sintering Conditions

As shown in FIG. 3, in all one-dimensionally arranged structural bodies using the particles having diameters of 270, 344, and 482 μm, the formation of the necks hardly occurs at a temperature up to 850° C. The formation of the necks rapidly occurs at 900° C., and the necks grow at 950° C., so that a neck diameter of approximately 30 μm is confirmed. However, when the necks formed at a sintering temperature of 950° C. or less are precisely observed, an initial neck is formed of a plurality of fine necks, and hence it is believed that the necks as described above are not sufficient for impregnation of the dissolving solution. In the case in which the sintering is performed at 1,050° C., which is just below the melting point, necks having a diameter of 35 μm or more and a high strength are formed, and hence it is believed that the impregnation of the dissolving solution can be easily performed. As shown in FIG. 3, the neck diameter is not considerably influenced by the particle diameter. Accordingly, it is believed that the most suitable sintering temperature for a three-dimensionally arranged structural body composed of copper particles is 1,050° C. regardless of the particle diameter.

III. Dielectric Properties of Dielectric Resin

As shown in FIG. 4, in all the dielectric resins composed of epoxy resins and Si, SiO₂, and TiO₂ powders at various volume contents, as the volume content thereof is increased, the increase in dielectric constant can be observed. However, when the SiO₂ powder is used, the dielectric constant thereof is low, and hence the increase in dielectric constant is not so significant. As for the Si and TiO₂ powders, when the volume content is 20 percent by volume, the dielectric constant is increased by approximately two times that obtained in the case in which the powder is not contained.

When the calculation results obtained by using equation (1) are compared to the measurement values, in the TiO₂ mixture, the calculation results and the measurement values well coincide with each other. On the other hand, in the Si mixture, the measurement values are considerably larger than the calculation values. The difference described above has not been clearly understood as of today; however, based on the above-described results, it is determined that an epoxy resin mixed with TiO₂ is a favorable material for the photonic crystal since a desired dielectric constant can be easily obtained by calculation and a high dielectric constant can also be obtained.

IV. Structural Body

As shown in FIG. 5A, the structural body is a laminate composed of 34 layers, the laminate having a side length of 10 mm at the bottom and a height of 6 mm, and has a strength sufficient to prevent breakage of the laminate caused by general handling. The bottom surface of the regular quadrangular pyramid corresponds to the (100) plane of the fcc structure, and the other surfaces correspond to the {111} planes. On the surface of this structural body, defects caused by falls of particles are observed at approximately 4 places; however, the probability of the defects present on the surface is merely 0.18%, and hence it is understood that very precise arrangement is performed. Furthermore, the distance between particles of the structural body is 378 μm and is not changed before and after the sintering, and hence the particles are not overlapped with each other even after the sintering.

As shown in FIG. 5B, the average neck diameter of this structural body is 34 μm, and it is understood that in the three-dimensional structural body, the neck equivalent to that obtained in the one-dimensional arrangement can be formed.

V. Photonic Crystal

In FIG. 6, black particle-shaped materials present in a transparent epoxy resin are air spheres which are formed after the copper particles are removed by dissolution, and it is understood that the copper particle-arranged structural body shown in FIG. 5A is precisely transferred.

As apparent from FIG. 7, it is understood that all the copper particles present in the resin are dissolved, residues are not allowed to remain, and even grain-boundary shapes are also very precisely transferred. In addition, since the coordination number of the fcc structure is 12, when the half of particle is polished in parallel to the (111) plane, three necks are to be found in the hemisphere. Small apertures present at the back of the air spheres in FIG. 7 are the necks described above. In some air spheres, the necks are not formed. The reason for this is that when the distribution in size of the copper particles is spread, the periodical structure in the vicinity of particles having difference in particle diameter therebetween is distorted, and as a result, the number of contact points is decreased. In addition, as also shown in FIG. 2, since slight surface undulations are generated on the particle surfaces caused by the presence of grain boundaries, the formation of the neck is also partly inhibited thereby. However, since the particles each form a neck with at least one of adjacent particles, and the dissolving solution is impregnated in the neck, it is understood that the dissolution of the particles can be carried out. The lattice constant of the fcc structure formed from the particles having a diameter of 267 μm used in this case is 378 μm according to the following equation, (lattice constant a)=(2/√2)×(particle radius r), and the lattice constant calculated based on the measured distance between particles shown in FIG. 7 is 380 μm; hence the two values described above are approximately equal to each other. From the results described above, it is understood that the change in shape of the lattice caused by sintering does not occur.

VI. Terahertz-Wave Transmission Properties

As shown by the dotted line in FIG. 8A, it is understood that in the solid body only composed of the epoxy resin, as the wave number is increased (that is, as the frequency is increased), the transmission of terahertz waves is decreased and that terahertz waves are not transmitted at a wave number of approximately 40 cm⁻¹ or more. Hence, in forming a photonic crystal used in the terahertz wave region hereinafter, improvement is required such that a dielectric material having a higher transmittance is used. As shown by the solid line in FIG. 8A, in a wave number of 15 to 21 cm⁻¹, the attenuation of the transmittance is apparently observed in the photonic crystal. In order to confirm whether the attenuation region of the transmittance is caused by the photonic gap or not, the comparison with the analysis result obtained in accordance with a plane wave expansion method is performed. In addition, according to FIG. 9 which shows the band structure, it is expected that the photonic crystal has a photonic stop gap in the <111> direction of the fcc structure. This photonic stop gap is in a normalized frequency of 0.68. to 0.77, and when converted into the wave number using the lattice constant calculated from the particle diameter, this value is in the range of 18.0 to 20.4 cm⁻¹. This region approximately coincides with the transmission attenuation region measured in FIG. 8A. Hence, it is confirmed that the photonic crystal formed using the structural body of monodisperse metal particles realizes a photonic stop gap in the terahertz wave region.

As shown by the dotted line in FIG. 8B, in the solid body of the TiO₂ mixed resin, the transmittance is considerably decreased as compared to the case of the solid body only composed of the epoxy resin, and the reason for this is believed that the terahertz-wave transmittance of TiO₂ itself is low. As shown by the solid line in FIG. 8B, also in the photonic crystal using the TiO₂ mixed resin, although the attenuation region of the transmittance is present in a wave number of 13 to 20 cm⁻¹, the position of the photonic stop gap is slightly shifted from that shown in FIG. 8A. When the calculation is performed by a plane wave expansion method using a lattice dielectric constant of 3.7 in consideration of the case in which a photonic crystal formed of the TiO₂ mixed resin is used, it is expected that the photonic stop gap appears in a wave number of approximately 16.9 to 19.6 cm⁻¹. As for the wavelength at which the stop gap appears, although the theoretical value and the measurement value are slightly different from each other due to the variation in particle diameter and the like, the values described above well coincide with each other.

As has thus been described, when monodisperse particles are used, a photonic crystal usable in a terahertz wave region can be formed, and in the photonic crystal of this example having a fcc structure, the stop gap appears in the <111> direction. In addition, it is understood that as the dielectric constant of the crystal lattice of the photonic crystal is increased, a wider photonic stop gap can be obtained and is shifted to a lower frequency side. Hence, when a material having a higher dielectric constant is used, a terahertz-wave control technique usable in a wider frequency region can be available. Furthermore, when a crystal having a graded dielectric constant and a graded structure is formed, a very wide bandgap can also be obtained.

What is claimed is:

1. A structural body used for manufacturing a photonic crystal in which air spheres are three-dimensionally arranged in a dielectric, comprising:
monodisperse particles which are three-dimensionally arranged,
wherein the monodisperse particles are each connected to at least one adjacent monodisperse particle with a neck provided therebetween.

2. The structural body used for manufacturing a photonic crystal, according to claim 1,
wherein the lattice constant of the structural body is in the range of 0.03 to 3 mm.

3. The structural body used for manufacturing a photonic crystal, according to claim 1,
wherein the monodisperse particles are formed by a process comprising the steps of:
filling a molten raw material in a crucible provided with a small hole; and
dripping droplets of the molten raw material each having a constant volume through the small hole by applying a pulse pressure to the crucible, whereby the droplets are formed into spheres due to its own surface tension and are solidified during dripping.

4. The structural body used for manufacturing a photonic crystal, according to claim 1,
wherein the monodisperse particles comprise a metal.

5. The structural body used for manufacturing a photonic crystal, according to claim 1,
wherein the monodisperse particles are arranged to form a face-centered cubic structure.

6. A method for manufacturing a structural body used for manufacturing a photonic crystal in which air spheres are three-dimensionally arranged in a dielectric, comprising the steps of:
placing monodisperse particles in a container;
arranging the particles three-dimensionally by applying vibration; and
performing sintering, whereby the particles are each connected to at least one adjacent monodisperse particle with a neck provided therebetween.

7. A method for manufacturing a photonic crystal in which air spheres are three-dimensionally arranged in a dielectric, comprising the steps of:
impregnating voids of the structural body manufactured by the manufacturing method according to claim 6 with a dielectric resin, followed by curing to form a composite; and
immersing the composite in a solution dissolving only the structural body of the composite so as to remove the structural body by dissolution, whereby a photonic crystal comprising the dielectric resin is formed.

8. The method for manufacturing a photonic crystal, according to claim 7,
wherein the monodisperse particles comprise copper;
the solution is an aqueous ferric chloride solution; and
the dielectric resin is an epoxy resin containing at least one of Si, SiO₂, and TiO₂.

9. A photonic crystal comprising:
a dielectric; and
air spheres three-dimensionally arranged in the dielectric.

10. The photonic crystal according to claim 9:
wherein the dielectric comprises a synthetic resin.

11. The photonic crystal according to claim 9:
wherein the dielectric comprises a synthetic resin and a dielectric powder.

12. The photonic crystal according to claim 9:
wherein the photonic crystal is manufactured by the method according to claim 7.
